(19) United States
(12) Patent Application Publication
(10) Pub. No.: US 2013/0139110 A1
(43) Pub. Date: May 30, 2013

(54) User Interface Image Navigation System for Use in Medical or Other Applications

(71) Applicant: Siemens Medical Solutions USA, Inc., Malvern, PA (US)

(72) Inventor: Irene Fang, Barrington, IL (US)

(73) Assignee: SIEMENS MEDICAL SOLUTIONS USA, INC., Malvern, PA (US)

(21) Appl. No.: 13/626,927

(22) Filed: Sep. 26, 2012

Related U.S. Application Data
(60) Provisional application No. 61/564,339, filed on Nov. 29, 2011.

(51) Int. Cl. G06F 3/048

(52) U.S. Cl. 715/838

(57) ABSTRACT

A user interface medical image display navigation system comprises a user interface enabling a user to enter data and commands. A display processor generates data representing at least one display image window including, a current medical image, a navigation configuration element enabling user selection of a group of images for navigation, a navigation window concurrently displayed with the current medical image and an image element enabling a user to navigate through the user selected group and alter multiple reduced size medical images. The at least one display image window presents the multiple reduced size medical images of the user selected group in a row and column matrix including a reduced size current medical image. The multiple reduced size medical images are substantially smaller than the current medical image and enabling user selection of one of the reduced size medical images as a new current medical image.

This is a non-provisional application of provisional application Ser. No. 61/564,339 filed Nov. 29, 2011, by I. Fang.

### FIELD OF THE INVENTION

This invention concerns a user interface medical image comprising a navigation window concurrently displayed with a medical image and including reduced size medical images and enabling a user to navigate through and alter the reduced size medical images.

### BACKGROUND OF THE INVENTION

Medical images stored in DICOM format follows the hierarchy of different levels of image object definitions (IOD), such as patient, study, time points, series and frames. A typical known medical imaging review software system displays image frames from a parent image series. In order to traverse between image frames, a vertical scroll bar is present on the left side of the image display. A known scrollbar takes up screen real-estate inside the window, and lacks a quick method of navigating to a specific image frame. Furthermore, known systems fail to facilitate navigation between a parent image series, and other image entities within the same DICOM storage hierarchy. A system according to invention principles addresses these deficiencies and related problems.

### SUMMARY OF THE INVENTION

A user interface system advantageously uses a graphical watermark context sensitive symbol (a User interface navigation window or icon) providing horizontal, vertical, and middle mouse wheel scrolling, for example, with each direction being configurable to navigate through a particular image entity (i.e., image frames, series). The interface facilitates access and jump to a specific element within a desired image entity. A user interface medical image display navigation system comprises at least one computer including, a user interface enabling a user to enter data and commands. A display processor generates data representing at least one display image window including, a current medical image, a navigation configuration element enabling user selection of a group of images for navigation, a navigation window concurrently displayed with the current medical image and an image element enabling a user to navigate through the user selected group and alter multiple reduced size medical images. The at least one display image window presents the multiple reduced size medical images of the user selected group in a row and column matrix including a reduced size current medical image. The multiple reduced size medical images are substantially smaller than the current medical image and enabling user selection of one of the reduced size medical images as a new current medical image.

### BRIEF DESCRIPTION OF THE DRAWING

FIG. 1 shows a user interface medical image display navigation system, according to invention principles.

FIG. 2 shows a Navigation window, according to invention principles.

FIG. 3 shows a Navigation window in an image display window, according to invention principles.

FIG. 4 shows a Navigation window hot spot movement control, according to invention principles.

FIG. 5 shows a Navigation window user interface navigation scrolling function and tooltip message initiated by hovering a cursor near top or bottom edges of the navigation window, according to invention principles.

FIG. 6 shows a Navigation window user interface scrolling function and tooltip message initiated by hovering a cursor near left or right edges of the navigation window, according to invention principles.

FIG. 7 shows Navigation window navigating context dialog medical image frames, according to invention principles.

FIG. 8 shows a Navigation window for navigating different context dialog medical image series, according to invention principles.

FIG. 9 shows a Navigation window context dialog when a cursor hovers over an indexing symbol, according to invention principles.

FIG. 10 shows additional Navigation window context dialog options, according to invention principles.

FIG. 11 illustrates an ECG-gated image acquisition in an RR interval divided into 8 portions (time bins) of equal duration with an image frame acquired in each portion and each time bin containing multiple frames where the number of frames equals the number of cardiac cycles over which images are acquired.

FIG. 12 shows a flowchart of a process used by a user interface medical image display navigation system, according to invention principles.

### DETAILED DESCRIPTION OF THE INVENTION

A system comprises a single user interface graphical context sensitive navigation window (symbol). The navigation window provides horizontal, vertical, and middle mouse wheel scrolling where each direction is configurable to navigate through a particular image entity (e.g., medical image frames, image series). The interface also enables a user to jump to a specific element within a desired image entity. The system overcomes deficiencies of a known scrollbar and provides additional functions enabling a user to easily navigate through image frames, between image series (e.g. of a DICOM image study), or other image entities presented inside an image review window, via user configuration, without taking up screen real estate. The system is plug compatible with image reviewing software applications, especially medical image review applications. The system further provides a user friendly, space saving user interface with functions of a scroll bar, together with configurable scroll context and precision indexing capabilities.

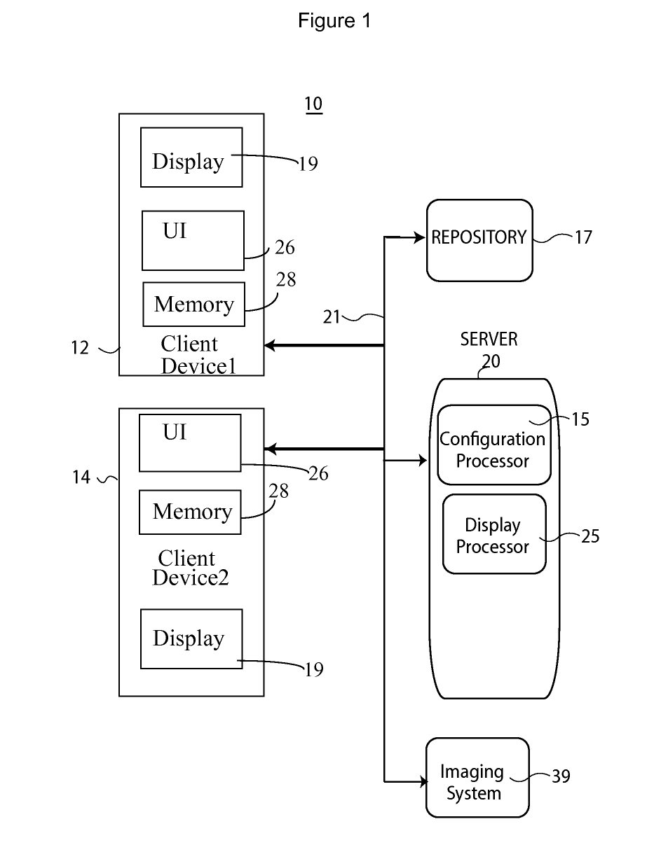

FIG. 1 shows user interface medical image display navigation system 10. The user interface navigation system is configurable by configuration processor 15 to provide navigation through various image entities in a medical image display application and to provide navigation for different image viewing applications. System 10 includes client (processing) devices 12 and 14 comprising a computer, workstation, notebook, PDA, phone or other device including a user interface 26, memory 28 and display 19. Device 12, 14 bidirectionally inter-communicate via network 21 with server 20, imaging system 39 and at least one repository 17. Server 20 in one embodiment includes configuration processor 15 and display processor 25. At least one repository 17 includes medical images and image series in DICOM or other data format.

System 10 (at least one computer) includes user interface 26 and display processor 25. User interface 26 enables a user to enter data and commands. Display processor 25 generates data representing at least one display image window including, a current medical image, a navigation configuration element enabling user selection of a group of images for navigation, a navigation window concurrently displayed with the current medical image and an image element enabling a user to navigate through the user selected group and alter multiple reduced size medical images. The navigation window presents multiple reduced size medical images of the user selected group in a row and column matrix including a reduced size current medical image and the navigation window enables user selection of one of the reduced size medical images. The multiple reduced size medical images are substantially smaller than the current medical image. Imaging system 39 such as an MR, CT scan, X-ray or ultrasound system, acquires medical images of a patient in response to an ECG or other heart electrical activity representative signal.

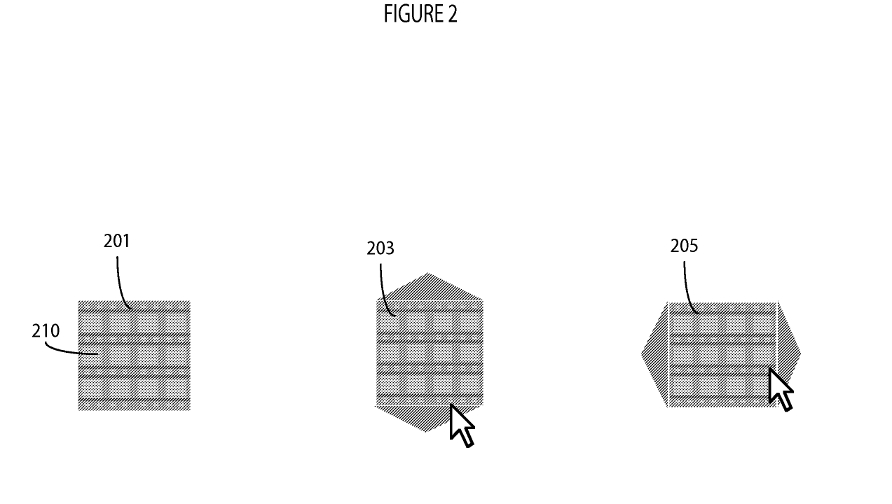

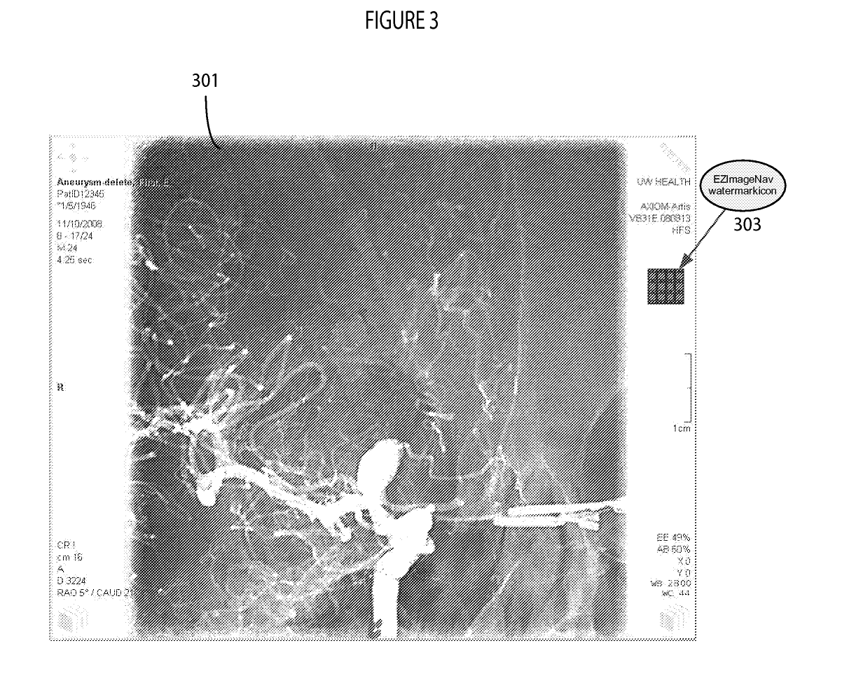

FIG. 2 shows a navigation window 201 (a Navigation symbol) presenting multiple reduced size medical images (e.g. image 210) of a user selected group in a row and column matrix. Navigation window 201 is positioned automatically by an executable application or by a user at a desired location on a display screen, typically (but not limited to) within a window where subject images are displayed. Navigation window 203 depicts the navigation window with a cursor hovering over window top or bottom. Navigation window 205 depicts the navigation window with a cursor hovering over window left or right. Windows 203, 205 show vertically and horizontally activating scrolling through the reduced size images. FIG. 3 shows navigation window 303 in image display window 301.

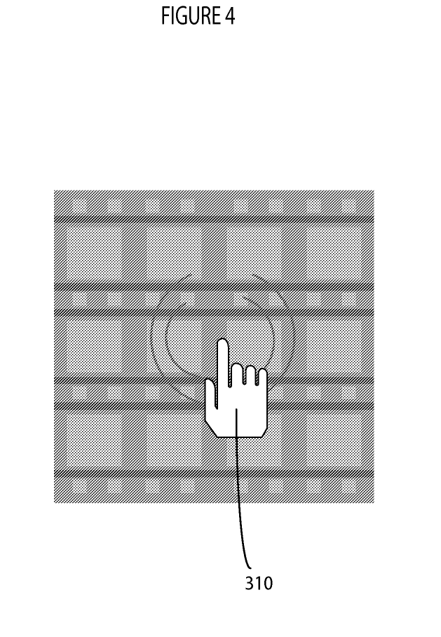

FIG. 4 shows a navigation window hot spot movement control. In response to a cursor hovering over a middle section of the navigation window 310, the cursor changes to a hand shape (or another shape which is different than the cursor), indicating that the navigation window can be moved to a different position. A user is able to drag the navigation window and drop it anywhere on the screen. The navigation window may be docked at the parent window edges, or float anywhere within or outside of the parent window. When docked, it moves with the parent window when the window is moved or resized.

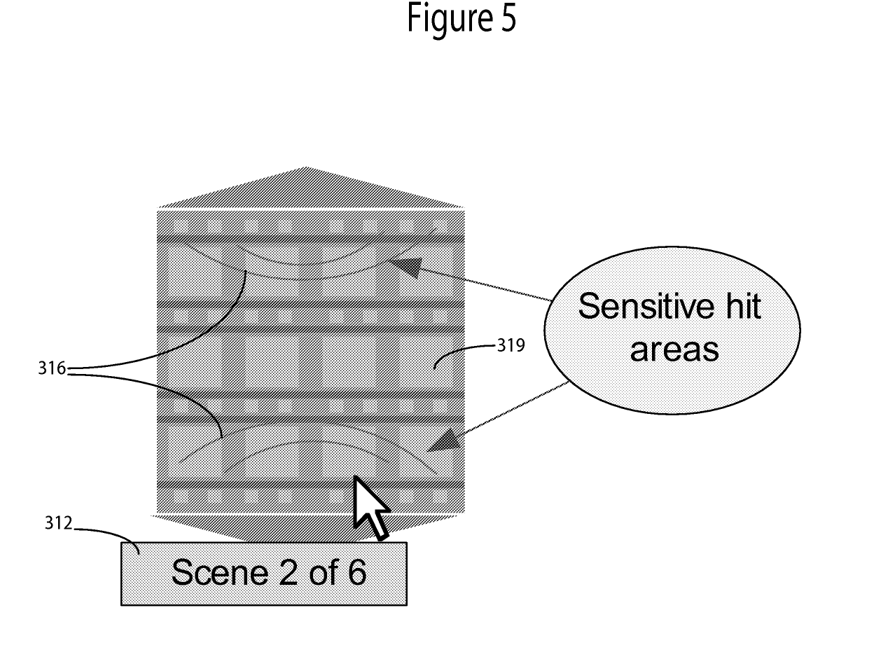

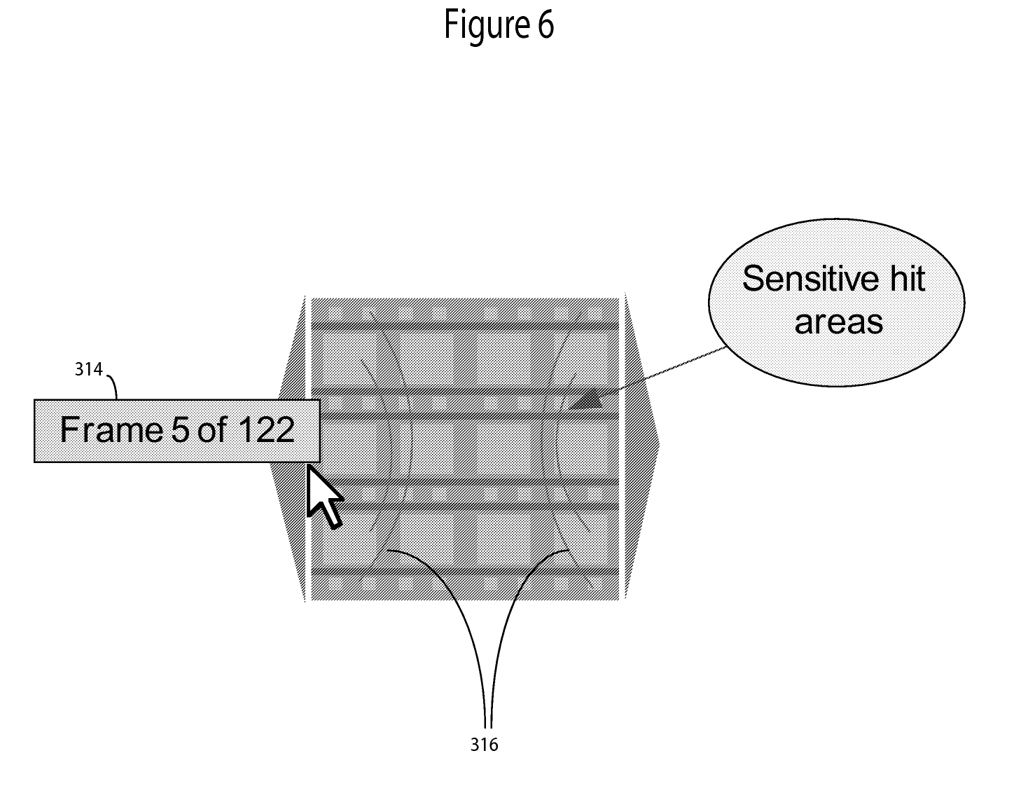

FIG. 5 shows a Navigation window user interface navigation scrolling function and tooltip message initiated by hovering a cursor near top or bottom edges of the navigation window. FIG. 6 shows a Navigation window user interface scrolling function and tooltip message initiated by hovering a cursor near left or right edges of the navigation window. In order to activate vertical or horizontal scrolling, a user hovers the mouse cursor over either the top, bottom or the right, left edges of the navigation window. The hit area is visually highlighted by turning a different color e.g. red (or by changing another visual attribute such as shading, highlighting, a pattern) when scrolling is activated. While a cursor is visually highlighted by being in the hit area, a user presses down a left mouse cursor button, for example, and a tooltip appears next to the cursor displaying the current scroll position indicating scene 2 of 6 (312) or frame 5 of 122 (314). Lines 316 are not part of the control, but illustrate activation sensitive areas near each edge of the Navigation window. A user employs a cursor to scroll the reduced size medical images, e.g. including image 319 and the tooltip message continuously updates with each scroll action activation. For maximum performance, as a cursor is used to scroll the navigation window up/down (or left/right), a tooltip message is continuously updated to show an updated index but the image presented does not change until scroll action activation stops.

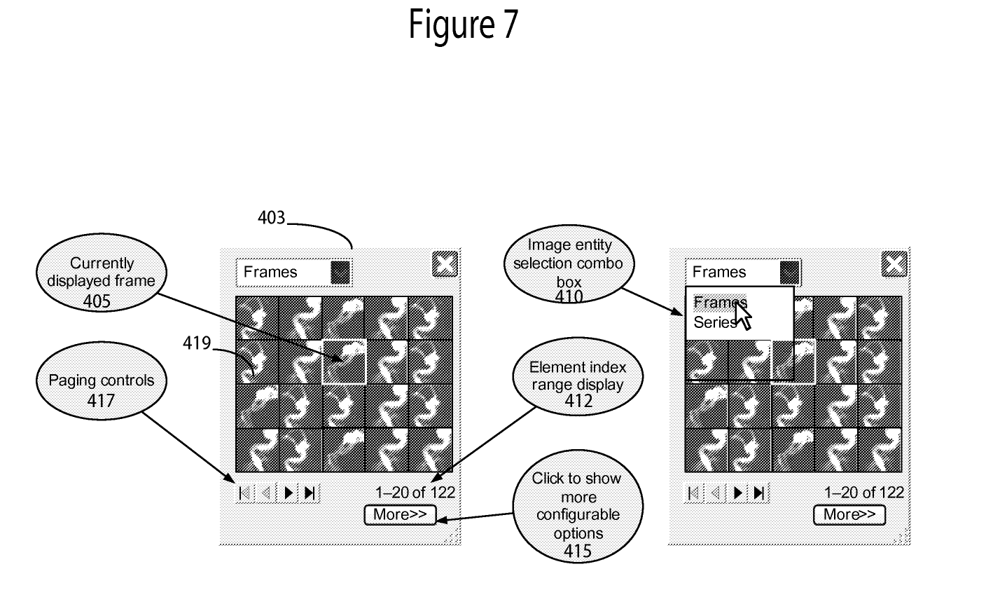

FIG. 7 shows Navigation window 403 for navigating context dialog medical image frames. In response to a user mouse right click anywhere on window 403, a modeless (floating) Context Dialog (window 403) is displayed on unit 19. The currently displayed image entity (i.e. frame) 405 is highlighted with a bold boarder. Image thumbnails e.g. thumbnail 419 shows the available elements within the selected image entity (e.g. image series) and index range 412 identifies the thumbnail image range in window 403 within an entity such as an image series (here image thumbnails 1-20 of images 1-122 of a series). A set of navigation buttons provides ways to access available elements within a selected image entity. Paging controls 417, for example, enable a user to page through blocks of thumbnail images of images 1-122 of the series. A user selects more button 415 to enable more configuration options of window 403.

A user is able to select an image entity from a list of available entities in box 410 such as image frames or series. The image entity entries of window 403 illustrate possible choices. A list of items in box 410 is configurable by initiating operation of an executable application based on specific requirements. In FIGS. 7, 8 and 9, “Frames” indicates the lowest level display element (i.e. the initiated application shows a list of image Frames for a selected series of multiple different image series), and “Series” indicates the parent element for the “Frames”, and each Series contains a list of frames. If the image entity selection box 410 is set to “Frames”, in response to a user double clicking (or otherwise selecting) a desired thumbnail icon, a display jumps (or scroll) to the selected frame.

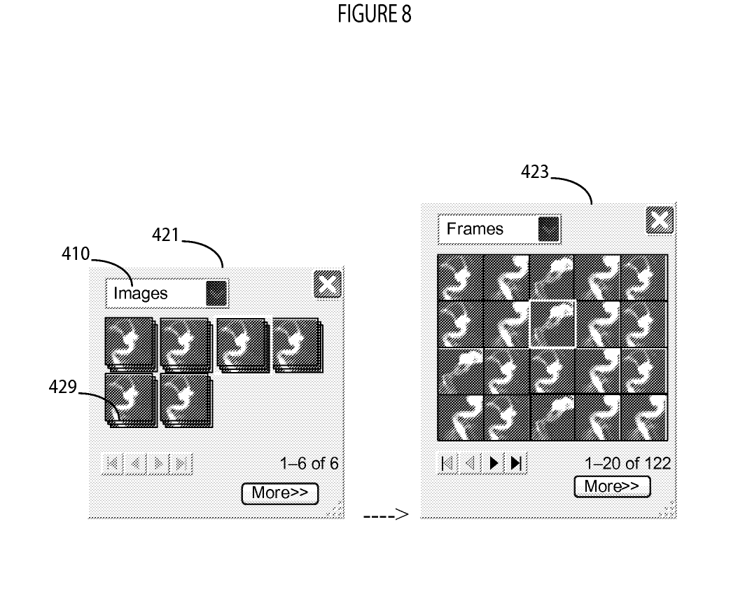

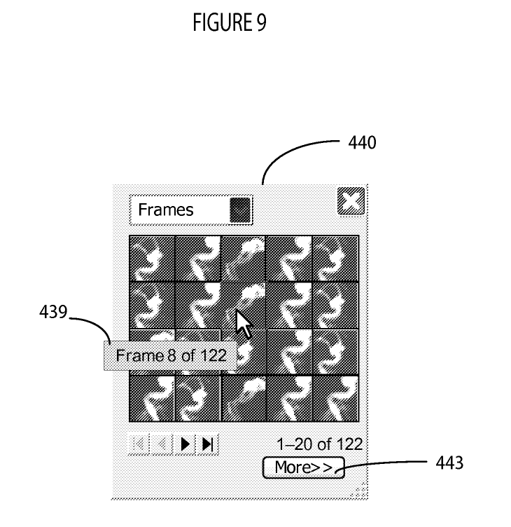

FIG. 8 shows Navigation window 421 for navigating different context dialog medical image series such as series depicted by element 429. If an entity selection in box 410 is set to “Series” and a user double clicks (or otherwise selects) a series thumbnail, navigation window 421 changes to window 423 and box 410 selection indicates “Frames”, and window 423 displays frame thumbnails from the selected series. A user is able to select a particular thumbnail image frame (e.g. by double clicking on a thumbnail) to initiate navigation to and display of the selected thumbnail frame in non-reduced size form as shown in image display window 301 (FIG. 3). Navigation window 423 and individual thumbnail images of a context Dialog are configurable in size and may be resized to show more or less indexing thumbnails. FIG. 9 shows Navigation window 440 context dialog when a cursor hovers over an indexing symbol. If a mouse is hovered over a specific indexing symbol (i.e. a frame), a tooltip message (e.g. message 439) displays to show the subject index number.

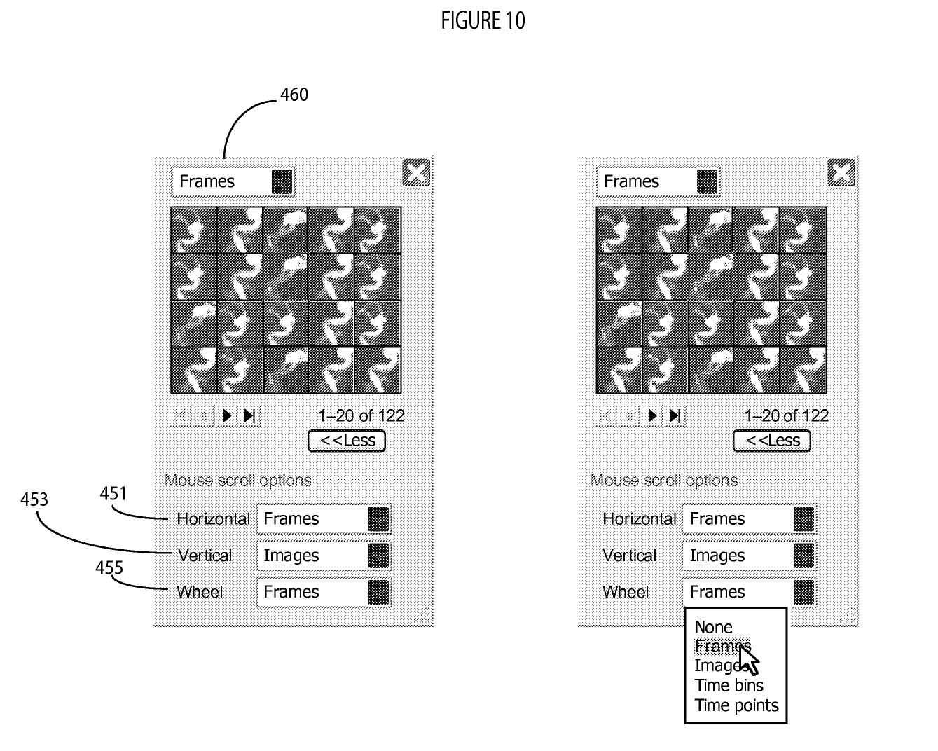

FIG. 10 shows additional Navigation window context dialog options including enabling configuration of vertical, horizontal, and scroll actions, for example. In response to a user selecting “More” button 443 of window 440 (FIG. 9), display processor 25 provides navigation window 460 with more scroll options 451, 453 and 455. A user is enabled to configure the scrolling context for an image entity for vertical, horizontal, and middle mouse scroll actions respectively, for example, using scroll option list selections 451, 453 and 455. Specifically, configuration processor 15 enables a user to configure scrolling actions for each mouse movement, i.e. option list 453 enables a user to configure click-and-drag in a vertical direction, option list 451 enables a user to configure click-and-drag in horizontal direction and option list 455 enables a user to configure scrolling the middle mouse wheel. Option lists 451, 453 and 455 are individually configurable to scroll through different image entities including image frames of a series, different image series, images of particular time portions (bins) of an ECG heart cycle and images associated with particular points of an ECG heart cycle such as an ECG P, Q, R, S, T, U wave points. Display processor 15 displays thumbnail index references in a context dialog to allow fast access to a specific image element such as a frame or image series.

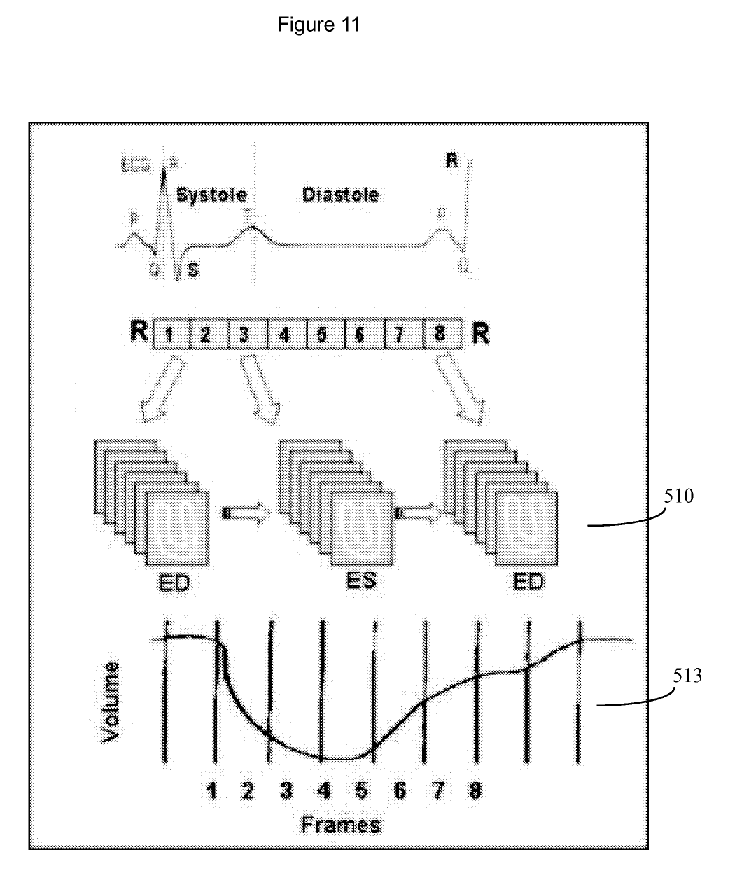

FIG. 11 illustrates an ECG-gated image acquisition in an RR interval divided into 8 portions (time bins) of equal duration with an image frame acquired in each portion and each time bin containing multiple portion specific frames where the number of frames equals the number of cardiac cycles over which images are acquired. The RR interval comprises 1 cardiac cycle and individual image frames are acquired over multiple cardiac cycles and stored separately in specific locations (“bins”) of computer memory 510. When image data in a bin is summed, a resultant image represents a specific phase of a cardiac cycle. Typically, a ventricle volume curve is obtained, which represents endocardial volume for each of 8 frames 513 (ED=end-diastole; ES=end-systole). A typical gated image display adaptively presents image frames across time bins in the same window, or employs a “time bin” filter so that frames from each time bin are displayed at a time. However, image entities vary based on imaging modality (such as MR, CT scan, X-ray, and ultrasound) and selectable image entities are automatically configured by processor 15.

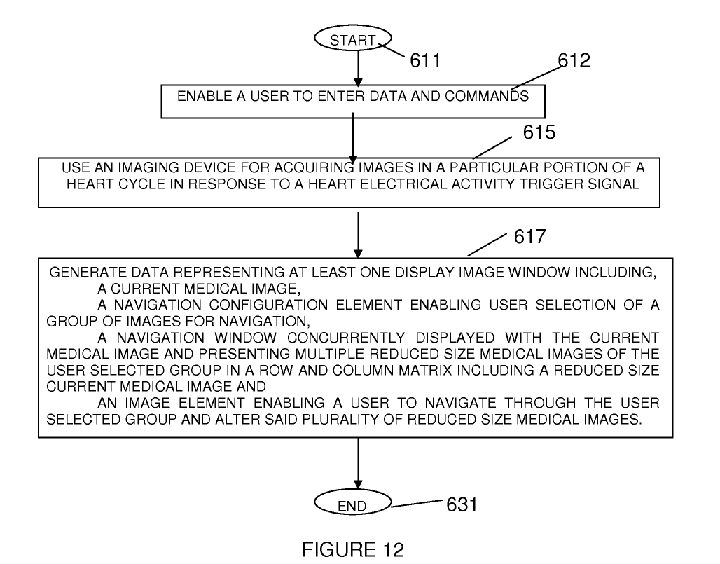

FIG. 12 shows a flowchart of a process used by user interface medical image display navigation system 10 (FIG. 1). In step 612 following the start at step 611, user interface 26 enables a user to enter data and commands. User interface 26 comprises at least one of, a mouse, touchscreen device, keyboard device or voice command interface device. Imaging device 39 in step 615 acquires medical images of a patient in a particular portion of a heart cycle in response to a heart electrical activity trigger signal. Cursor movement navigation control is via at least one of the user interface devices.

In step 617, display processor 25 generates data representing at least one display image window. The at least one display image window includes, a current medical image, a navigation configuration element enabling user selection of a group of (e.g. DICOM compatible) images for navigation, a navigation window concurrently displayed with the current medical image and an image element enabling a user to navigate through the user selected group and alter the multiple reduced size medical images. The navigation window presents multiple reduced size medical images (such as thumbnail images) of the user selected group in a row and column matrix including a reduced size current medical image. The multiple reduced size medical images are substantially smaller than the current medical image and enable user selection of one of the reduced size medical images as a new current medical image.

The navigation configuration element enables user selection of a group of images for navigation from groups comprising, (a) an image study comprising multiple image series, (b) an image series, (c) images comprising multiple individual image frames of an anatomical volume, (d) frames comprising multiple individual image frames, (e) images associated with a particular heart cycle portion, (f) images comprising multiple individual image frames within a predetermined heart cycle associated time period and (g) images comprising multiple individual image frames acquired substantially at a predetermined heart cycle associated time point.

The at least one display image window is within a single display image and includes a user interface device configuration element enabling user configuration of horizontal and vertical cursor movement navigation controls of the interface device by selection of at least one of, (a) a group of images for navigation by the horizontal cursor movement navigation control and (b) a group of images for navigation by the vertical cursor movement navigation control. The at least one display image window includes a symbol graphical element for scrolling through the multiple reduced size medical images in a selected direction to select one of the reduced size medical images as a new current medical image. The symbol graphical element is movable to a location in a window in response to cursor control. The scrolling is performed in incremental steps in a selected direction in response to user selection of a direction indicator. In one embodiment, the at least one display image window includes a user interface device configuration element enabling user configuration of a mouse-wheel for vertical or horizontal scrolling. The process of FIG. 12 terminates at step 631.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and is conditioned using executable instructions to perform special purpose functions not performed by a general purpose computer. A processor may be coupled (electrically and/or as comprising executable components) with any other processor enabling interaction and/or communication there-between. Computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s). A user interface processor or generator is a known element comprising electronic circuitry or software or a combination of both for generating display elements or portions thereof. A user interface comprises one or more display elements enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A graphical user interface (GUI), as used herein, comprises one or more display elements, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the elements for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display elements in response to signals received from the input devices. In this way, the user interacts with the display elements using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

The system and processes of FIGS. 1-12 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The system comprises a single user interface graphical context sensitive navigation window enabling a user to one-click navigate to a specific element (image frame, series) within a desired image entity (image sequence, series, study and provides functions of a scroll bar, together with configurable scroll context and precision indexing capabilities. Further, the processes and applications may, in alternative embodiments, be located on one or more (e.g., distributed) processing devices on a network linking the units FIG. 1. Any of the functions and steps provided in FIGS. 1-12 may be implemented in hardware, software or a combination of both. No claim element herein is to be construed under the provisions of 35 U.S.C. 112, sixth paragraph, unless the element is expressly recited using the phrase “means for.”

What is claimed is:

1. A user interface medical image display navigation system, comprising:
at least one computer including,
a user interface enabling a user to enter data and commands;
a display processor for generating data representing at least one display image window including,
a current medical image,
a navigation configuration element enabling user selection of a group of images for navigation,
a navigation window concurrently displayed with said current medical image and presenting a plurality of reduced size medical images of the user selected group in a row and column matrix including a reduced size current medical image, said plurality of reduced size medical images being substantially smaller than said current medical image and enabling user selection of one of said reduced size medical images as a new current medical image and
an image element enabling a user to navigate through the user selected group and alter said plurality of reduced size medical images.

2. A system according to claim 1, wherein
said navigation configuration element enables user selection of a group of images for navigation from groups comprising, (a) an image study comprising a plurality of image series and (b) an image series.
said navigation configuration element enables user selection of a group of images for navigation from groups comprising, (i) images comprising a plurality of individual image frames of an anatomical volume, (ii) frames comprising a plurality of individual image frames and (iii) images associated with a particular heart cycle portion.

3. A system according to claim 2, wherein
said navigation configuration element enables user selection of a group of images for navigation from groups comprising, (i) images comprising a plurality of individual image frames within a predetermined heart cycle associated time period and (ii) images comprising a plurality of individual image frames acquired substantially at a predetermined heart cycle associated time point.

4. A system according to claim 3, wherein
said group of images is DICOM compatible.

5. A system according to claim 1, wherein
said at least one display image window is within a single display image.

6. A system according to claim 1, wherein
said at least one display image window includes a user interface device configuration element enabling user configuration of horizontal and vertical cursor movement navigation controls of said interface device by selection of at least one of,
(a) a group of images for navigation by the horizontal cursor movement navigation control and
(b) a group of images for navigation by the vertical cursor movement navigation control.

7. A system according to claim 6, wherein
the cursor movement navigation control is via said mouse.
the cursor movement navigation control is via at least one of the user interface devices.

8. A system according to claim 1, wherein
said at least one display image window includes a symbol graphical element for scrolling through said plurality of reduced size medical images in a selected direction to select one of said reduced size medical images as a new current medical image, said symbol graphical element being movable to a location in a window in response to cursor control.

9. A system according to claim 8, wherein
said scrolling is performed in incremental steps in a selected direction in response to user selection of a direction indicator.

10. A system according to claim 1, wherein
said at least one display image window includes a user interface device configuration element enabling user configuration of a mouse-wheel for vertical or horizontal scrolling.

11. A system according to claim 1, wherein
said reduced size medical images are thumbnail images.

12. A user interface method for medical image display navigation, comprising the activities of:
employing at least one computer for,
enabling a user to enter data and commands;
generating data representing at least one display image window including,
a current medical image,
a navigation configuration element enabling user selection of a group of images for navigation,
a navigation window concurrently displayed with said current medical image and presenting a plurality of reduced size medical images of the user selected group in a row and column matrix including a reduced size current medical image, said plurality of reduced size medical images being substantially smaller than said current medical image and enabling user selection of one of said reduced size medical images as a new current medical image and
an image element enabling a user to navigate through the user selected group and alter said plurality of reduced size medical images.

13. A method according to claim 12, wherein
said navigation configuration element enables user selection of a group of images for navigation from groups comprising, (a) an image study comprising a plurality of image series and (b) an image series.

14. A method according to claim 13, wherein
said navigation configuration element enables user selection of a group of images for navigation from groups comprising, (i) images comprising a plurality of individual image frames of an anatomical volume and (ii) frames comprising a plurality of individual image frames.

15. A method according to claim 14, wherein
said navigation configuration element enables user selection of a group of images for navigation from groups comprising, (i) images comprising a plurality of individual image frames within a predetermined heart cycle associated time period, (ii) images comprising a plurality of individual image frames acquired substantially at a predetermined heart cycle associated time point and (iii) images associated with a particular portion of a heart cycle.

16. A method according to claim 15, wherein
using an imaging device for acquiring images in said particular portion of said heart cycle in response to a heart electrical activity trigger signal.

17. A method according to claim 12, wherein
said at least one display image window includes a user interface device configuration element enabling user configuration of horizontal and vertical cursor movement navigation controls of said interface device by selection of at least one of,
(a) a group of images for navigation by the horizontal cursor movement navigation control and
(b) a group of images for navigation by the vertical cursor movement navigation control.

18. A method according to claim 12, wherein
said at least one display image window includes a symbol graphical element for scrolling through said plurality of reduced size medical images in a selected direction to select one of said reduced size medical images as a new current medical image, said symbol graphical element being movable to a location in a window in response to cursor control.

19. A method according to claim 12, wherein
said reduced size medical images are thumbnail images.
